(19) United States
(12) Patent Application Publication
(10) Pub. No.: US 2008/0297229 A1
(43) Pub. Date: Dec. 4, 2008

(54) LOW POWER CMOS VOLTAGE REFERENCE CIRCUITS

(76) Inventor: Navin Kumar Ramamoorthy, Bangalore (IN)

Correspondence Address: IBM CORPORATION;ROCHESTER IP LAW DEPT. 917, 3605 HIGHWAY 52 NORTH, ROCHESTER, MN, 55901-7829, US

(21) Appl. No.: 11/756,023

(22) Filed: May 31, 2007

(51) Int. Cl. G05F 1/567; G05F 1/10

(52) U.S. Cl. 327/513; 327/540

(57) ABSTRACT

A CMOS voltage reference circuit for a low voltage (1v), low power supply application is described. The circuit achieves a temperature coefficient of 31 ppm for a relatively large temperature range of −40 C to 125 C. A combination of subthreshold current characteristics and moderate inversion operation of MOSFET's are utilized in conjunction to achieve a fairly stable temperature independent output voltage reference (V_{REF}) from the circuit.

### FIELD OF THE INVENTION

This invention relates to a temperature compensated low power voltage reference circuit, for providing relatively stable voltage reference over a relatively large temperature range.

### BACKGROUND OF THE INVENTION

Designing analog circuits at low supply voltage has become increasingly important. This is due to the fact that there is a great demand in battery-powered portable devices and systems. As a result, integrated circuits that consist of both analog and digital circuits are required to be operated at a supply voltage lower than 1.5 V. Furthermore, advances in CMOS processes also demand the reduction in supply voltage down to the same level due to reliability issues for sub-micron CMOS processes. However, this trend presents a great challenge in designing analog circuits such as amplifiers, filters, and data converters, due to the fact that the threshold voltages of the devices in these processes do not scale down at the same rate as the supply voltages.

Another important building block in analog circuits is the voltage reference, which is usually required in many analog and mixed signal systems such as communication systems and data acquisition systems, as well as some digital systems such as dynamic random access memories (DRAM's). Voltage references are a key element/block in a number of integrated circuits, like high resolution A/D and D/As converters, signal processing blocks, battery power management systems and precision Voltage regulators. The most widely used schemes for realization of integrated voltage references with low temperature dependence are based on the conventional silicon bandgap approach using CMOS technology in conjunction with parasitic vertical BJT transistors. However, the conventional CMOS bandgap reference does not work for lower power supply voltages (like 1 Volt) as the minimum output voltage of the conventional Bandgap reference is 1.23 V, which is limited by the bandgap of silicon.

Recently, different techniques have been proposed to design precise voltage references at low supply voltages with a main emphasis on the reduction of the reference output voltage value, which is designed to be equal to or proportional to the material bandgap voltage. These techniques include using a fraction of the voltage across the diodes by resistive subdivision and the use of dynamic threshold MOS transistor (DTMOS), which is based on lowering the material bandgap by electrostatic field. However, the supply voltages of most bandgap references are, in fact, limited by the input common mode range of the operational amplifier (opamp), which is required to produce a proportional to the absolute temperature (PTAT) voltage or current.

Many integrated circuit functions require precise voltage and current references. For example, an analog-to-digital converter typically requires a precise voltage reference to establish and quantize an analog input voltage range. In another example, many analog filters, such as transconductance-capacitance (g.sub.m C) filters, have filter gain and roll off frequency characteristics that depend upon their bias currents. A precise current reference is useful for generating accurate bias currents in such filters and other circuits.

Many battery powered electronics applications need current and temperature compensated voltage reference circuits that operate at low power supply voltages and power consumption. There is a critical need for circuits that operate at low power supply voltages and draw less current from the low voltage power supply in order to increase battery longevity. There is also a need for such circuits in which the value of the reference voltage and reference current are capable of fine adjustment. There is a further need for such reference circuits in which the resulting reference voltage is temperature compensated, i.e. the sensitivity of the reference voltage to temperature variations is reduced. There is a need for a circuit that can accommodate power supply voltage variations.

Without a way to provide a stable reference voltage particularly for low temperature variations the promise of this technology may never be fully achieved.

### SUMMARY OF THE INVENTION

Accordingly, the present invention provides a circuit comprising a current source circuit configured to generate and provide a current that is proportional to the absolute temperature (I_{PTAT}), the current source electrically coupled to a reference circuit configured to provide an output reference voltage (V_{REF}). The reference circuit is configured to receive the current (I_{PTAT}) from the current source and provide a stable reference voltage (V_{REF}) at an output node between the current source circuit and the reference circuit, where the reference voltage (V_{REF}) generated by the circuit is stable of a variable temperature range.

The reference voltage (V_{REF}) is provided across a source and a gate connection of a transistor of the reference circuit, the transistor having a negative temperature coefficient and being biased in the moderate inversion regions. The current source circuit consists of a current generating circuit and a current mirror circuit. The current generating circuit containing a first cascode circuit and a second cascode circuit. The current (I_{PTAT}) is generated in a first cascode circuit consisting of NMOS transistors biased in the sub threshold region, and provided to a second cascode circuit consisting of PMOS transistors that are biased in the saturations region. The current (I_{PTAT}) generated in the first cascode circuit is facilitated to the current mirror circuit via the second cascode circuit and then provided to the reference circuit to provide a stable voltage reference (V_{REF}). Other embodiments are also disclosed.

### BRIEF DESCRIPTION OF THE DRAWINGS

FIG. 1 illustrates an exemplary embodiment of a circuit 100 to provide a stable reference voltage (V_{REF}) where the current source 10 represents a reference current (I_{PTAT}).

FIG. 2 illustrates an exemplary embodiment of a circuit 200 comprising a current source circuit 100 of FIG. 1 and a current reference circuit, the circuit 200 configured to provide a stable reference voltage.

FIG. 3 illustrates an exemplary embodiment of a graph 300 indicating measurements of drain current versus gate-source voltage variation of at different temperatures for the transistor 150 of FIGS. 1 and 2.

FIG. 4 illustrates the temperature sensitivity of V_{PTAT} and V_{CTAT} voltages with respect to temperature in 410 and the resultant temperature compensated Output Voltage reference V_{REF} variation with respect to temperature in 420.

### DETAILED DESCRIPTION

Where reference is made in any one or more of the accompanying drawings to steps and/or features, which have the same reference numerals, those steps and/or features have for the purposes of this description the same function(s) or operation(s), unless the contrary intention appears. The terms V_{DD} refers to a positive voltage supply to the circuit and the term V_{SS} refers to negative voltage supply or the ground. The term reference current, current proportional to absolute temperature, (I_{PTAT}) current are used synonymously.

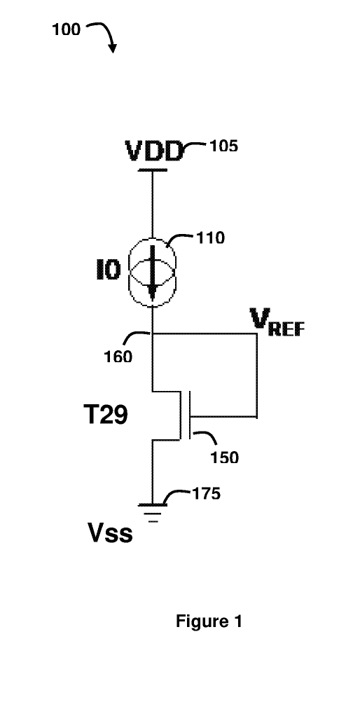

FIG. 1 illustrates an exemplary embodiment of a circuit 100 configured to provide a stable reference voltage (V_{REF}). The circuit 100 is coupled between a positive voltage supply 105 (V_{DD}), which supplies a respective voltage to the circuit 100, and a negative voltage supply 175 (V_{SS}), which is also referred to as the ground connection. The circuit 100 consists of a current source circuit 110, which is configured to generate and provide a current that is proportional to the absolute temperature (I_{PTAT}), also referred to as the reference current or current. The reference current (I_{PTAT}) generated from the current source circuit 110 is provided to a transistor (T29) 150, the drain of which is coupled to the current source circuit 110 and the source of which is coupled to the ground (V_{SS}). The circuit 100 is configured to generate a stable reference voltage (V_{REF}) at an output node 160. The output reference voltage (V_{REF}) is advantageously provided to other integrated circuits such as analog-to-digital converters, digital-to-analog converters, MPEG circuits, onchip voltage regulators etc. It should be apparent to a person skilled in the art that any circuit that requires an output reference voltage (V_{REF}) can advantageously use the circuit 100.

By providing the transistor (T29) 150 with a current (I_{PTAT}), the transistor which has a negative temperature coefficient and is biased in the moderate inversion regions is capable of producing a stable reference voltage (V_{REF}) over a relatively large varying temperature range of −40 to 125 degree Centigrade. Typically for a fixed bias current I_{O} (not shown in the figure) from the current source circuit 110, the gate-source reference voltage (V_{REF}) of the transistor, which is preferably a MOS transistor, biased in the moderate inversion regions decreases linearly with temperature. For a constant current bias I_{O}, the reference voltage (V_{REF}) exhibits a complementary to absolute temperature (CTAT) behavior, which is linear in nature. Therefore, the fixed/constant current bias I_{O} is replaced by a current source circuit that is configured to generate a current that is proportional to the absolute temperature (I_{PTAT}). An advantage of such a current source that generate a current (I_{PTAT}) such that the current (I_{PTAT}) compensates for the temperature sensitivity of the transistor (T29) 150 which is biased in the moderate inversion region.

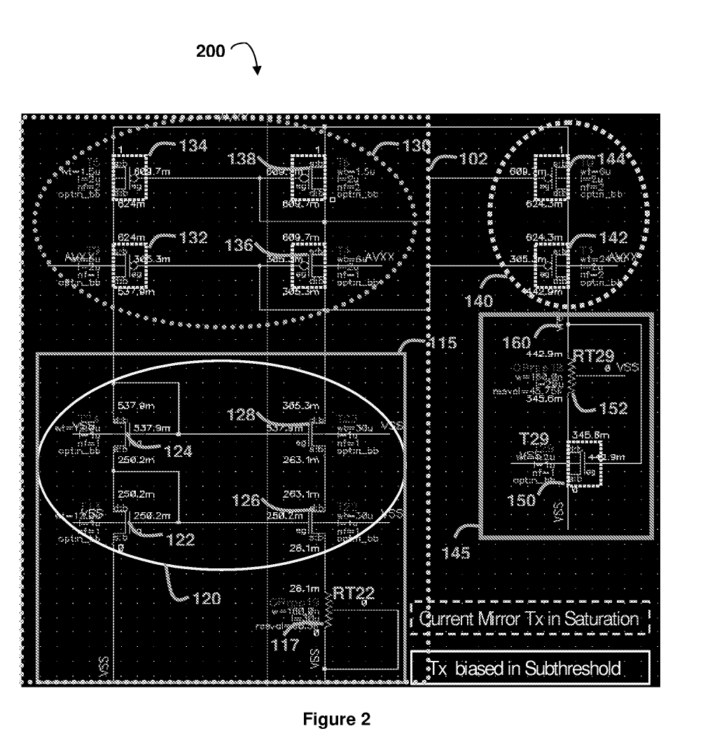

FIG. 2 illustrates an exemplary embodiment of a circuit 200 comprising a current source circuit 100 of FIG. 1, configured to provided a reference current and a current reference circuit, the circuit 200 configured to receive the reference current form the current source circuit 100 and provide a stable reference voltage. The current source circuit 100 as detailed consists of a current generating circuit 102 that is electrically coupled to a current mirror circuit 140. The current generating circuit consists of a first cascode current mirror circuit 120, which consists preferably of NMOS transistors 122, 124, 126, 128 which are biased in the sub-threshold regions. Each transistor arranged to perform its defined function. The transistors 122, 124, 126, 128 are coupled to each other the transistor 126 is coupled to a resistor (RT22) 117 in its source terminal, which is then arranged to generate the current for the circuit. Since the lower NMOS transistors 122, 124, 126, 128 are biased in sub-threshold region, these transistors develop/generate the reference current or I_{PTAT} current in conjunction with the resistor (RT22) 117.

The reference current or I_{PTAT} current generating circuit 102 further comprises a second current mirror cascode circuit 130, which preferably consists of PMOS transistors 132, 134, 136, 138, the PMOS transistors are biased in the regular saturation region. The second cascode current mirror circuit 130 consisting of PMOS transistors, which facilitates for current mirroring into the current mirror circuit 140, which further comprises preferably of PMOS transistors 142 and 144 electrically coupled to the transistors 136 and 138.

For a typical MOS transistor biased in sub-threshold region, the I_{D} versus V_{GS} are governed by the equations:

$$\begin{matrix}{I}_{sub} = {I}_{o} {exp}^{\frac{( {V}_{GS} - {V}_{T} )}{{nU}_{T}}} Λ Λ Λ Λ Λ Λ Λ & [ 1 ] \\ {V}_{GS} = {nU}_{T} ln ( \frac{{I}_{sub}}{{I}_{o}} ) + {V}_{T} Λ Λ Λ Λ Λ Λ Λ & [ 2 ] \\ Δ {V}_{GS} = {nU}_{T} ln ( \frac{{I}_{sub 1}}{{I}_{sub 2}} ) Λ Λ Λ Λ Λ Λ Λ Λ Λ & [ 3 ] \\ {I}_{D} = \frac{Δ {V}_{GS}}{R} = \frac{{nU}_{T}}{R} ln ( \frac{{I}_{sub 1}}{{I}_{sub 2}} ) = \frac{{nU}_{T}}{R} ln ( K ) Λ Λ Λ Λ & [ 4 ]\end{matrix}$$

Equation (4) shows that, the transistor drain current (I_{D}) is proportional to the thermal voltage U_{T} of the transistor. Hence, biasing the lower set of transistors i.e., the NMOS transistors in the first cascode current mirror circuit 120 assists in generation of reference current (I_{PTAT}) which has a positive temperature coefficient. It is apparent to a person skilled in the art that current increases with temperature. The upper set of transistors in the second current mirror circuit 130 forms a pair of PMOS cascode current mirror. This current mirroring arrangement is used to reflect the I_{PTAT} current to the current mirror circuit 140. All the transistors that form part of the second PMOS cascode current mirror 130 and 140 are biased in saturation/strong inversion region. This I_{PTAT} current generated using current source circuit 110 is injected into the drain arm of the transistor (T29). This Transistor (T29) is biased in moderate inversion region.

The current mirror circuit 140 along with the second cascode current mirror circuit 130 serves to ensure that the current is same in both arms of the first stage by providing relatively high impedance. The I_{PTAT} current is provided to a reference circuit 145 to the transistor (T29) 150 which has a negative temperature coefficient and is biased in the moderate inversion region via a resistor (RT29) 152. The output reference voltage is measured at a node 160 between the reference circuit 145 and the current mirror circuit 140. By replacing the fixed current bias I_{O} in a typical circuit with the I_{PTAT} current from the current source circuit 110, which consists of the current generating circuit 102 and the current mirror circuit 140, a relatively stable reference voltage (V_{REF}) is obtained as an output at the node 160 over a relatively large temperature range.

The circuit 200 achieves a temperature coefficient of 31 ppm for a relatively large temperature range of −40° C. to 125° C. A combination of the sub-threshold current characteristics and moderate inversion operation of a MOSFET are utilized in conjunction to achieve a fairly temperature independent voltage reference (V_{REF}). For a fixed bias current I_{O}, instead of the (I_{PTAT}) reference current in FIG. 1, the gate-source voltage of the MOS transistor (T29) 150 biased for moderate inversion region decreases linearly with temperature. Therefore, for a constant current bias I_{O}, the V_{GS} exhibits a V_{CTAT} (Complementary to absolute temperature) nature. To achieve a temperature compensated voltage reference (V_{REF}), the fixed current bias I_{O} is replaced by a I_{PTAT} (Proportional to absolute temperature) current source such that the current source 102 compensates for the temperature sensitivity of MOS transistor biased in moderate inversion. This I_{PTAT} current source is realized by using set of PMOS cascode current mirrors 130, which are biased in saturation, and by biasing the lower set of NMOS transistors 120 in the sub-threshold region. Instead of constant current bias I_{O}, the current I_{PTAT}, which is the reference current is mirrored using the cascode current mirrors circuit 140 to bias the transistor (T29) 150 in moderate inversion region.

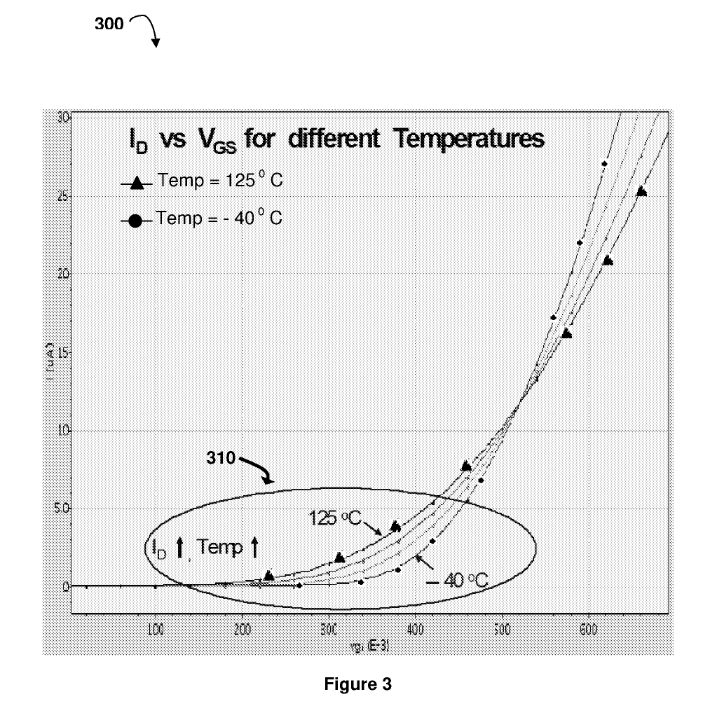

FIG. 3 illustrates an exemplary embodiment of a graph 300 indicating measurements of drain current versus gate-source voltage variation of at different temperatures for the transistor 150 of FIGS. 1 and 2. The x-axis represents a measurement of the voltage measured across the gate-source V_{GS} region measured in milli-volts, and the y-axis represent the drain current I_{D} measured in micro-Amperes for the transistor 150 shown in FIGS. 1 and 2. As temperature increases the drain current I_{D} also increases in the subthreshold region 310 in FIG. 3 indicating the I_{PTAT} nature of the circuit. The graph 300 shows measurements between a temperature range of −40 C (line marked with dots) to 125 C (line marked with triangles). The variation of the drain current I_{D} as compared to the gate-source voltage is seen to be exponential in the subthreshold region. Therefore, in accordance with this invention the current is compensated with a current I_{PTAT}, that is a current proportional to absolute temperature, thereby compensating for the temperature sensitivity of the transistor 150 which is biased in the moderate inversion region.

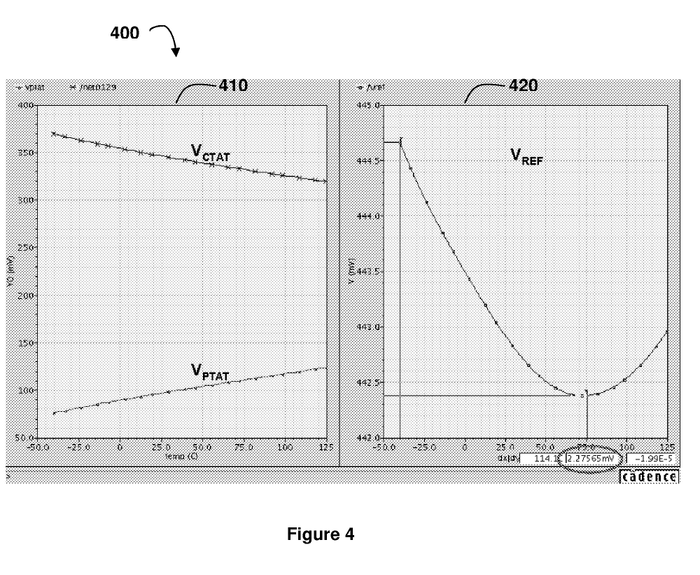

The simulated results shown in FIG. 4, which illustrates an exemplary embodiment of a graph 400, has a mean reference voltage of 443 mV at room temperature with a temperature sensitivity of around 2.3 mV over the entire temperature range of −40 C to 125 C. In the graph of FIG. 4, 410 represents a plot of the V_{PTAT} and V_{CTAT}, linear voltage variations over a relatively larger temperature range. The x-axis represents Temperature in Centigrade and the y-axis represents Voltage measured in milli-volts. The graph 420 shows the temperature variation of output reference voltage V_{REF}. The y-axis represent measurement of Voltage in milli-volts and for a wide temperature range, noticeably the mean reference voltage of 443 mV at room temperature with a temperature sensitivity of around 2.3 mV over the entire temperature range of −40 C to 125 C, thereby providing a substantially stable reference voltage output from the circuit illustrated in FIGS. 1 and 2.

For those of ordinary skill in the art will appreciate that the circuit depicted in FIG. 2 may vary, and may be advantageously used in integrated circuits such as on-chip voltage regulators, low power battery management systems, high precision voltage references for Analog to Digital (A/D) converters, D/A converters, stable bias circuits for amplifiers and other signal processing blocks, stable references for memories etc.

The accompanying figures and this description depicted and described embodiments of the present invention, and features and components thereof. Those skilled in the art will appreciate that any particular program nomenclature used in this description was merely for convenience, and thus the invention should not be limited to use solely in any specific application identified and/or implied by such nomenclature. Therefore, it is desired that the embodiments described herein be considered in all respects as illustrative, not restrictive, and that reference be made to the appended claims for determining the scope of the invention.

Although the invention has been described with reference to the embodiments described above, it will be evident that other embodiments may be alternatively used to achieve the same object. The scope of the invention is not limited to the embodiments described above, but can also be applied to software programs and computer program products in general. It should be noted that the above-mentioned embodiments illustrate rather than limit the invention and that those skilled in the art will be able to design alternative embodiments without departing from the scope of the appended claims. In the claims, any reference signs should not limit the scope of the claim. The invention can be implemented by means of hardware comprising several distinct elements.

What is claimed is:

1. A circuit comprising:
a current source circuit configured to generate and provide a current proportional to absolute temperature (I_{PTAT} or reference current), the current source circuit electrically coupled to a reference circuit configured to provide a output reference voltage (V_{REF}), wherein the reference circuit is configured to receive the reference current from the current source and provide a stable reference voltage (V_{REF}) at an output node between the current source circuit and the reference circuit with varying temperatures.

2. The circuit of claim 1, wherein the reference circuit comprises comprising a resistor and a transistor, the resistor coupling the current source circuit to the transistor of the reference circuit.

3. The circuit of claim 2, wherein the transistor in the reference circuit comprises a negative temperature coefficient.

4. The circuit of claim 2, where in the transistor in the reference circuit is biased in a moderated inversion region.

5. The circuit of claim 1, wherein the current source circuit comprising a current generating circuit and a current mirror circuit, the current generating circuit further comprising a first cascode current mirror circuit and a second cascode current mirror circuit, the first cascode being electrically coupled to the second cascode current mirror circuit.

6. The circuit of claim 5, wherein the first cascode current mirror circuit comprising a plurality of NMOS transistors biased in the sub-threshold regions.

7. The circuit of claim 6, wherein the first cascode current mirror circuit in conjunctions with a resistor is configured to generate the reference current (I_{PTAT}).

8. The circuit of claim 5, wherein the second cascode current mirror circuit comprising a plurality of PMOS transistors biased in the saturation region.

9. The circuit of claim 8, wherein the second cascode current mirror circuit of the current generating circuit is electrically coupled to the current mirror circuit.

10. The circuit of claim 5, wherein the reference current (I_{PTAT}) generated by the first cascode circuit is facilitated to the current mirror circuit by means of the second cascode current mirror circuit.

11. The circuit of claim 5, wherein the current mirror circuit is configured to provide the current the reference current (I_{PTAT}) to the reference circuit.

12. The circuit of claim 11, wherein the transistor in the reference circuit receives the reference current (I_{PTAT}) from the current mirror circuit and is configured to provide substantially stable reference voltage over a temperature range of −40° C. to 125° C.

13. A method for compensating temperature sensitivity of a transistor in a reference circuit, the reference circuit being electrically coupled to a current source circuit, the method comprising
generating a current proportional to absolute temperature (I_{PTAT} or reference current) in the current source circuit;
receiving the reference current (I_{PTAT}) in the reference circuit;
providing a stable reference voltage (V_{REF}) at an output node between the current source circuit and the reference circuit for varying temperatures.

14. The method of claim 13, wherein the transistor in the reference circuit is configured to provide substantially stable reference voltage over a temperature range of −40° C. to 125° C.

15. The method of claim 13, wherein the reference circuit comprises a resistor and the transistor, the resistor coupling the current source circuit to the transistor of the reference circuit.

16. The method of claim 15, wherein the transistor in the reference circuit is biased in the moderate inversion region.

17. The method of claim 13, wherein the current source circuit comprising a current generating circuit and a current mirror circuit, the current generating circuit further comprising a first cascode current mirror circuit and a second cascode current mirror circuit, the first cascode being electrically coupled to the second cascode current mirror circuit.

18. The method claim 17, wherein the first cascode current mirror circuit comprising a plurality of NMOS transistors biased in the sub-threshold regions, the first cascode current mirror circuit conjunctions with a resistor is configured to generate the reference current (I_{PTAT}); and the second cascode current mirror circuit comprising a plurality of PMOS transistors biased in the saturation region, the second cascode current mirror circuit of the current generating circuit is electrically coupled to the current mirror circuit, and the reference current (I_{PTAT}) generated by the first cascode circuit is facilitated to the current mirror circuit by means of the second cascode current mirror circuit.

19. The method of claim 18, further comprises
providing the reference current (I_{PTAT}) generated by the current source circuit to the reference circuit via the current mirror circuit.

20. An integrated circuit comprising
a circuit comprising a current source circuit configured to generate and provide a current proportional to absolute temperature (I_{PTAT} or reference current), the current source circuit electrically coupled to a reference circuit configured to provide a output reference voltage (V_{REF}), wherein the reference circuit is configured to receive the reference current from the current source and provide a stable reference voltage (V_{REF}) at an output node between the current source circuit and the reference circuit with varying temperatures.

21. The integrated circuit of claim 20, wherein the reference circuit comprises comprising a resistor and a transistor, the resistor coupling the current source circuit to the transistor of the reference circuit, the transistor in the reference circuit comprises a negative temperature coefficient, and the transistor in the reference circuit is biased in a moderated inversion region.

22. The integrated circuit of claim 20, wherein the current source circuit comprising a current generating circuit and a current mirror circuit, the current generating circuit comprising a first cascode current mirror circuit including a plurality of NMOS transistors biased in the sub-threshold regions, a second cascode current mirror circuit comprising a plurality of PMOS transistors biased in the saturation region, the first cascode being electrically coupled to the second cascode current mirror circuit, the second cascode current mirror circuit of the current generating circuit is electrically coupled to the current mirror circuit, and the first cascode current mirror circuit in conjunctions with a resistor is configured to generate the reference current (I_{PTAT}).

23. The integrated circuit of claim 22, wherein the reference current (I_{PTAT}) generated by the first cascode circuit is facilitated to the current mirror circuit by means of the second cascode current mirror circuit, and the current mirror circuit is configured to provide the current the reference current (I_{PTAT}) to the reference circuit.

24. The integrated circuit of claim 22, wherein the transistor in the reference circuit is receives the reference current (I_{PTAT}) from the current mirror circuit and is configured to provide substantially stable reference voltage over a temperature range of −40° C. to 125° C.
